(19) United States
(12) Patent Application Publication
(10) Pub. No.: US 2009/0058811 A1
(43) Pub. Date: Mar. 5, 2009

(54) PRESS-KEY STRUCTURE

(75) Inventor: CHING-TING LIN, Yilan County (TW)

Correspondence Address: WPAT, PC, 7225 BEVERLY ST., ANNANDALE, VA, 22003, US

(73) Assignee: DARFON ELECTRONICS CORP., Taoyuan (TW)

(21) Appl. No.: 12/196,549

(22) Filed: Aug. 22, 2008

(30) Foreign Application Priority Data
Sep. 4, 2007 (TW) 096214761

(51) Int. Cl. G06F 3/02

(52) U.S. Cl. 345/168

(57) ABSTRACT

A press-key structure is disclosed, which comprises: a keycap; a scissors-type supporting part; a substrate; and an elastic part. In an exemplary embodiment, the scissors-type supporting part is configured with a first and a second pivot axes; the press-key structure further comprises a first clasp part formed with a guiding ramp, a second clasp part formed as an inversed L-shaped structure, and at least a guiding block formed with a ramp, all being disposed on the substrate in a manner that the ramp of the at least one guiding block is configured to lean toward the second clasp part, while connecting the first and the second pivot axes respectively to the first clasp part and the second clasp part for enabling the keycap to move up and down relative to the substrate.

### FIELD OF THE INVENTION

The present invention relates to a press-key structure, and more particularly, to a press-key structure capable of being assembled rapidly by the use of a supporting part configured with a guiding block.

### BACKGROUND OF THE INVENTION

With rapid advance of technology as well as the improvement of our living quality, computers are becoming commonplace in various applications, such as communication, business transaction, word processing, computer graphic design, and so on. Thus, keyboards, being the input devices widely used in various electronic apparatuses relating to the aforesaid applications, should be designed with keys capable of being pressed smoothly and exactly for ensuring a command or data to be inputted into its corresponding computer correctly in a rapid and convenient manner.

With the mature of the keyboard industry as well as its applications, the quality demand for keyboards as input devices are becoming higher and higher so that the profit for producing keyboard is minimized. Thus, for the keyboard manufacturers, it is important to have a keyboard with simplified structure that can be produced faster than conventional keyboards. Thus, it is in need of a press-key structure for keyboards capable of being assembled rapidly.

### SUMMARY OF THE INVENTION

In view of the disadvantages of prior art, the object of the present invention is to provide a press-key structure capable of being assembled rapidly by the use of a supporting part configured with a guiding block.

To achieve the above object, the present invention provides a press-key structure, comprising:
a keycap;
a scissors-type supporting part, configured with a first and a second pivot axes;
a substrate, having a first clasp part, a second clasp part, and at least a guiding block formed thereon in a manner that the at least one guiding block is disposed at a position next to the second clasp part; and
an elastic par;
wherein, the first clasp part is formed with a guiding ramp so as to shape the first clasp part into a part with wider top and narrower bottom while enabling an accommodation space to be formed beneath the guiding ramp; and the second clasp part is formed as an inversed L-shaped structure; and the guiding block is configured with a ramp in a manner that it is inclined toward the second clasp part for forming another accommodation space between the inverted L-shaped second clasp part and the guiding block; and the first and the second pivot axes are connected respectively to the first clasp part and the second clasp part for enabling the keycap to move up and down relative to the substrate.

By the cooperation of the guiding block and the guiding ramp of the first clasp part, the first and the second pivot axes of the scissors-type supporting part can be guided smoothly to their designated positions so that the aforesaid press-key structure can be assembled rapidly.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic diagram showing a press-key structure according to an exemplary embodiment of the invention.

FIG. 2 is a schematic view of a substrate used in a press-key structure of the invention.

FIG. 3 shows a press-key structure of the invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

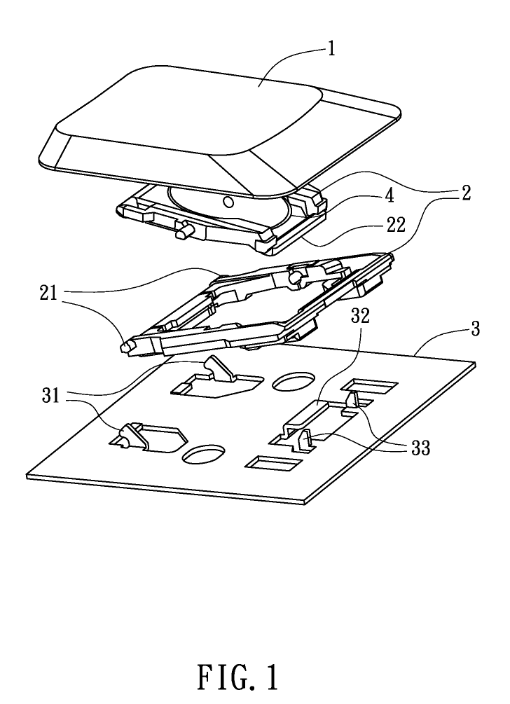

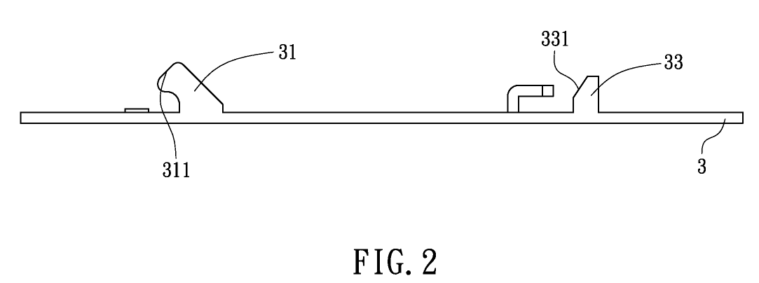

Please refer to FIG. 1 and FIG. 2, which show a press-key structure and its substrate. As shown in FIG. 1, the press-key structure is comprised of a keycap 1, a supporting part 2, a substrate 3 and an elastic part 4, in which the supporting part 2 is a scissor-type structure composed of two intersecting components. Moreover, the scissor-type structure supporting part 3 is configured with a first and a second pivot axes 21, 22 while the two pivot axes 21, 22 are connected to the substrate 3 in respective. In this exemplary embodiment, the substrate 3 has a first clasp part 31, a second clasp part 32, and at least a guiding block 33 formed thereon, in which the guiding block 33, being configured with a ramp 331, is disposed at a position next to the second clasp part 32; and the first clasp part 31 is formed with a guiding ramp 311 so as to shape the first clasp part 31 into a part with wider top and narrower bottom while enabling an accommodation space to be formed beneath the guiding ramp 311. Moreover, the second clasp part 32 is formed as an inversed L-shaped structure so that as the ramp 331 of the guiding block 33 is inclined toward the second clasp part 32, there is another accommodation space being formed between the inverted L-shaped second clasp part 32 and the guiding block 33. In addition, as the first and the second pivot axes 21, 22 are connected respectively to the first clasp part 31 and the second clasp part 32, the keycap is enabled to move up and down relative to the substrate 3.

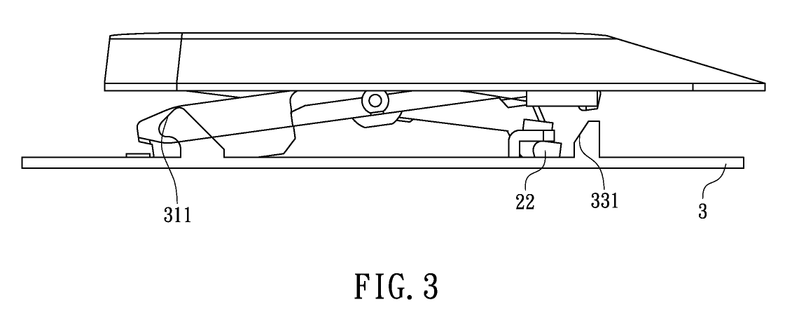

As shown in FIG. 3, when he second pivot axis 22 is guided by the ramp 331 of the guiding block to press on the substrate 3, it will be push along the surface of the substrate 3 to be received in the accommodation space formed by the inverted L-shaped second clasp part 32, and the same time that the first pivot axis 21 will be driven to press on the substrate 3 by the guiding of the guiding ramp 311 of the first clasp part 31 and eventually pushing the first pivot axis 21 into the accommodation space of the first clasp part 31. In FIG. 3, it is noted that there is a space formed in the supporting part that can be used for accommodating the elastic part 4. Thereafter, as soon as the keycap 1 is fixed to the two ends of the supporting part, the assembly of the press-key structure is accomplished.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A press-key structure, comprising:
a supporting part, configured with a first and a second pivot axes; and
a substrate, having a first clasp part, a second clasp part, and at least a guiding block formed thereon;
wherein, the first clasp part is formed with a guiding ramp; the second clasp part is formed as an inversed L-shaped structure;
and the guiding block is configured with a ramp in a manner that it is inclined toward the second clasp part; and the first and the second pivot axes are connected respectively to the first clasp part and the second clasp part for enabling the keycap to move up and down relative to the substrate

2. The press-key structure of claim 1, wherein the at least one guiding block is disposed at a position next to the second clasp part.

3. The press-key structure of claim 1, wherein the supporting part is a scissor-type supporting part.

4. The press-key structure of claim 1, wherein by the forming of the guiding ramp on the first clasp part, the first clasp part is shaped into a part with wider top and narrower bottom while enabling an accommodation space to be formed beneath the guiding ramp.

5. The press-key structure of claim 1, wherein by the inclination of the guiding block's ramp toward the second clasp part, another accommodation space is formed between the inverted L-shaped second clasp part and the guiding block.
